(19) United States
(12) Patent Application Publication
(10) Pub. No.: US 2021/0045418 A1
(43) Pub. Date: Feb. 18, 2021

(54) FLAVOR AND CONSUMMABLE COMPOSITIONS

(71) Applicant: Givaudan SA, VERNIER (CH)

(72) Inventors: Sabine VOLLENWEIDER, Wettswil am Albis (CH); Gabriele WEHRLE, Winterthur (CH)

(21) Appl. No.: 16/980,392

(22) PCT Filed: Mar. 25, 2019
(86) PCT No.: PCT/EP2019/057385

§ 371 Date: Sep. 12, 2020

(30) Foreign Application Priority Data
Mar. 26, 2018 (GB) 1804794.4

(51) Int. Cl. A23L 27/10; A23L 27/00

(52) U.S. Cl. CPC A23L 27/10; A23L 27/88; A23L 27/84

(57) ABSTRACT

A flavor composition based on edible insect-derived material is provided. The flavor composition includes an edible insect protein or fat. Consumable compositions containing a consumable base and the insect-derived flavor composition are also provided. Processes for preparing the insect-derived flavor composition and the consumable compositions including the insect-derived flavor composition, and for imparting flavor to a consumable or affecting the flavor or aroma profile of a consumable are further provided.

### TECHNICAL FIELD

The present disclosure relates to flavor compositions based on edible insect-derived material. The present disclosure also relates to consumable compositions containing a base and the insect-derived flavor composition, and processes for making the insect-derived flavor compositions and the consumable compositions.

### BACKGROUND

Insecta (ie, Insects) are a class of animals that are classified in the Phylum Arthopoda, Subphylum Hexapoda. Insects are the most diverse group of animals found on the Earth. There are over 1 million species of insects described; this represents over half of all known living organisms. Insects remain a highly nutritious and healthy source of food. They are known to be high in fat, protein, vitamins, minerals and fiber. It is possible to process insects into powder, particulate, or paste forms and to extract valuable protein, fats, vitamins, minerals, chitin from them. Edible insects also inhabit a large variety of habitats across the globe and represent a potentially inexhaustible resource as a food source. Insects can be easily harvested in the wild or raised in large quantities in commercial farm systems, and processed for human consumption or animal feed.

The practice of eating insects is known as entomophagy. According to the Food and Agricultural Organization of the United Nations, nearly 2,000 different species of insects are regularly consumed by 2 billion people in more than 80 countries across Asia, Africa and the Americas. Edible Insects. Future Prospects For Food and Feed Security, Food and Agricultural Organization of the United Nations, Rome, 2013. Some commonly consumed insects include ants, bees, beetles (such as mealworm), caterpillars, cicadas, crickets, dragonflies, flies, grasshoppers, leafhoppers, locusts, planthoppers, termites and wasps. Several scientific analyses also confirm the balanced and healthy nutritional compositions of insects such as crickets, locusts and mealworms, and that the production of feed and food from insect will have a far less negative impact on the environment than production of other farm animals. “Insects. Food Safety First—First Time Right. Regulatory Roadmap for Insect Products in Feed and Food Applications. International Producers of Insects for Feed and Food”

The United Nations expects the human population to grow by 2050 to more than 9 billion people. Humans consume roughly 40% of the biomass that the land and the coastal seas produce. A large amount of the Earth's total land is already used for agriculture. Furthermore, the oceans are also over-fished. Expanding the amount of land used for agricultural livestock production or increasing ocean fishing in an effort to meet the food needs of such increases in the human population; these are also not sustainable solutions over time. Given the real possibility that the mass production of meat (beef, pork, chicken) and fish may not be indefinitely sustainable, what is needed are processes to obtain these and other nutrients from sustainable sources, and to incorporate the nutrient-rich streams from insects, especially nutrient streams rich in fat and protein, into compositions are suitable for consumable or edible compositions.

### SUMMARY

Disclosed are flavor compositions that comprise material derived from edible insects, and consumable compositions containing the flavor composition comprising the insect-derived material.

According to a first illustrative embodiment, the flavor composition comprises an insect-derived protein.

According to a second illustrative embodiment, the flavor composition comprises an insect-derived fat.

According to a third illustrative embodiment, the consumable composition comprises a consumable or edible base and an insect-derived protein.

According to a fourth illustrative embodiments, the consumable composition comprises a consumable or edible base and an insect-derived fat.

Additionally provided is a method of imparting a flavor to a consumable. According to a fifth illustrative embodiment, the method comprises combining a consumable or edible base with a flavor composition comprising an insect-derived protein.

According to a sixth illustrative embodiment, the method of imparting a flavor to a consumable comprises combining a consumable or edible base with a flavor composition comprising an insect-derived fat.

Additionally provided is a method of affecting the aroma profile of a consumable.

According to a seventh illustrative embodiment, the method comprises combining a consumable or edible base with a flavor composition comprising an insect-derived protein.

According to an eighth illustrative embodiment, the method of affecting the aroma profile of a consumable comprises combining a consumable or edible base with a flavor composition comprising an insect-derived fat.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature.

The terms “about,” “approximately,” “essentially,” “substantially,” any other version thereof, or any other similar relative term, or similar term of approximation, are defined as being close to as understood by one having ordinary skill in the art. By way of non-limiting, illustrative embodiments, these terms are defined to be within 10% of recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount or concentration range is described in the present disclosure, it is intended that any and every amount or concentration within the range, including the end points, is to be considered as having been expressly disclosed. For example, the disclosure of “a range of from about 1 to about 10” is to be read as indicating each and every possible number along the continuum between about 1 and about 10. It is to be understood that the inventors appreciate and understand that any and all data points within the range are to be considered to have been specified, and that the inventors have possession of the entire range and all points within the range.

Disclosed are flavor compositions based on insect-derived materials. The insect-derived material may include insect-derived proteins, insect-derived fats, and combinations thereof. The term “fat” is used interchangeably herein with the terms “lipids” and “oils.” The flavor and consumable compositions disclosed herein can be prepared free or substantially of components or materials from animal meat and fish origin.

According to certain illustrative embodiments, disclosed are meat-free meat flavor compositions comprising an insect-derived protein. The insect-derived protein is used to replace the meat protein in a flavor composition to prepare a meat-free meat flavor composition.

According to certain illustrative embodiments, disclosed are meat-free meat flavor compositions comprising insect-derived fats. The insect-derived oil is used to replace the meat fat in a flavor composition to prepare a meat-free meat flavor composition.

There is no limitation on the type of species of edible insects that may be used to prepare the flavor compositions and consumable compositions so long as insect material has nutritional value to the human diet and for non-human animal feeds, and that the material can be extracted from the insect. The term “insects” refers to insects in any development stage, such as adult insects, insect larvae and insect pupae. According to illustrative embodiments, the fat, protein and chitin fractions are obtained from insect larvae or worms. According to other illustrative embodiments, the fat, protein and chitin fractions are obtained from insect pupae. A large variety of insects and worms can be used. Illustratively, edible insects or edible worms are used. More illustratively, the insects include, without limitation, flies, bugs, mosquitos, butterflies, moths, cicadas, termites, bees, ants, wasps, beetles, grasshoppers, or crickets. According to certain illustrative embodiments, the edible insects used to prepare the flavor compositions are selected from any insect within the Phylum Arthropoda. The Phylum Arthropoda includes invertebrate animals having an external skeleton, a segmented body and paired jointed appendages.

According to other illustrative embodiments, the edible insects used to prepare the flavor composition are selected from any insect within the Subphylum Hexapoda. The Subphylum Hexapoda includes the largest number of species of Arthropoda and also includes certain other wingless Arthropoda. The Subphylum Hexapoda includes invertebrate animals having an external skeleton, a consolidated thorax and three pairs of jointed appendages.

Without limitation, the insects may belong to the following species: (Black soldier fly (Hermetia illucens), house fly (Musca domestica), mealworm (Tenebrio Molitor), migratory locust (Locusta migratoria), cricket (Gryllidae) and combinations of these species. Other illustratively useful insects include, Silkworm Pupae (Bombyx Mori), Bamboo worms (also referred to as, bamboo borers) (Omphisa fuscidentalis), grass moth larvae (Crambidae, fam.), palm weevil larvae (Rhynchophorus spp.) and Waxworms (Pyralidae gen.)

According to certain illustrative embodiments, the Hexapoda used to prepare the flavor composition is Hermetia illucens. (Phylum, Arthropoda; Subphylum, Hexapoda; Class, Insecta; Family, Stratiomyidae; Genus, Hermetia; Species, H. illucens). H. illucens are commonly referred to as the black soldier fly. H. illucens are very efficient at producing protein and are edible to humans. The larvae of H. illucens are known as a sustainable source of protein for human diets, aquaculture, animal feeds, and pet food. It has been reported that H. illucens may contain up to 42% protein, amino acids and minerals such as calcium.

According to certain illustrative embodiments, the Hexapoda used to prepare the flavor composition is Tenebrio molitor. (Phylum, Arthropoda; Subphylum, Hexapoda; Class, Insecta; Family, Tenebrionidae; Genus, Tenebrio; Species, T molitor). T molitor are commonly referred to as mealworms, yellow mealworms, mealworm beetles, and darkling beetles. T molitor are high in protein content and are known to be edible for humans. T molitor are able to recycle food grade plant waste materials of low quality into animal feed and human food sources that are high in protein and fat. The larvae of T molitor are also used has pet food for birds, fish, small mammals, and reptiles, and are also used as fishing bait.

According to certain illustrative embodiments, the Hexapoda used to prepare the flavor compositions is Locusta migratoria. (Phylum, Arthropoda; Subphylum, Hexapoda; Class, Insecta; Family, Acrididae; Genus, Locusta; Species, L. migratoria). L. migratoria is referred to as the migratory locust. L. migratoria are rich in protein and fat, and are edible by humans.

Without limitation, and only by way of illustration, suitable sources of insect-derived fat, protein, mineral materials are commercially available from Ynsect (Evry, France) whole defatted Tenebrio molitor larvae (Protein P1-P3), Protix (Dongen, The Netherlands) Hermetia illucens larvae (LipidX, ProteinM, ProteinG, Chitin X), such as those insect-derived materials disclosed and prepared in accordance with WO 2013/191548 A1, and Thailand Unique, Locusta migratoria adult (Locust whole insect powder).

The insects may be processed into nutrient rich feeds and streams for human consumption by processes known in the art. The process for obtaining nutrient rich streams from insects of human consumption broadly involves selecting a desired species based on its known fat and protein content and profiles, squashing a plurality of insects or worms of the desired species to obtain a pulp, and extracting the fat, protein and chitin fractions from the insect or worm pulp. The fat, protein and chitin fractions are extracted from the pulp by a physical separation step thereby providing separate fat, protein and chitin fractions for further down-stream processing. Without limitation, and only by way of illustration, PCT Publication No. WO 2013/191548 A1, incorporated herein by reference, discloses a suitable process for converting insects and worms into valuable nutrient-rich streams for human consumption. WO 2013/191548 A1 discloses a process by which fat-containing, protein-containing, and chitin-containing fractions for human consumption may be obtained from insects and worms by pulping/squashing insects or worms into a suitable pulp, subjecting the pulp to enzymatic hydrolysis and heating steps, and extracting the fat, protein and chitin fractions from the hydrolyzed and heated pulp.

The insect-based or insect-derived flavor compositions can be used to prepare consumable or edible compositions. The edible or consumable compositions may include food products, beverage products, pharmaceuticals, nutraceuticals, and dietary supplements.

Beverage products include, without limitation, carbonated beverages, alcoholic drinks such as beers, wines and spirits, non-alcoholic drinks such as soft drinks, mineral and aerated waters, fruit drinks, fruit juices, coffee, artificial coffee, tea, cocoa, including forms requiring reconstitution including, without limitation, beverage powder, milk based beverage powder, sugar-free beverage powder, beverage syrups, beverage concentrates, instant coffee, instant tea, and instant cocoa.

Pharmaceuticals, nutraceuticals and dietary supplements may be in the form of orally ingestible product forms, such as powders, caplets, solid capsules, liquid capsules, gel capsules, gels, lozenges, pills, tablets, liquids, solutions, drops, emulsions, elixirs, syrups, dissolvable films, and edible films.

The food products may include human food and non-human animal food and feeds. The non-human animal foods or feeds may include pet foods, such as cat food, dog food, fish food and rodent food, farm animal feeds, and zoo animal feeds. Broadly, consumables include, but are not limited to, foodstuffs of all kinds, savoury products, confectionery products, baked products, sweet products, fermented products, dairy products, beverages, oral care products, nutraceuticals and pharmaceuticals.

Exemplary consumables include, but are not limited to, chilled snacks, sweet and savoury snacks, fruit snacks, chips/crisps, extruded snacks, tortilla/corn chips, popcorn, pretzels, nuts, other sweet and savoury snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, meat analogues, frozen pizza, chilled pizza, soup, canned soup, dehydrated soup, instant soup, chilled soup, UHT soup, frozen soup, pasta, canned pasta, dried pasta, chilled/fresh pasta, noodles, plain noodles, instant noodles, cups/bowl instant noodles, pouch instant noodles, chilled noodles, snack noodles, dried food, dessert mixes, sauces, dressings and condiments, herbs and spices, spreads, jams and preserves, honey, chocolate spreads, nut-based spreads, and yeast-based spreads.

Exemplary savoury products include, but are not limited to, salty snacks (potato chips, crisps, nuts, tortilla-tostada, pretzels, cheese snacks, corn snacks, potato-snacks), ready-to-eat popcorn, microwaveable popcorn, pork rinds, nuts, crackers, cracker snacks, breakfast cereals, meats, aspic, cured meats (ham, bacon), luncheon/breakfast meats (hotdogs, cold cuts, sausage), tomato products, margarine, peanut butter, soup (clear, canned, cream, instant, ultrahigh temperature “UHT”), canned vegetables, mayonnaise, vegan mayonnaise and pasta sauces.

Exemplary confectionery products include, but are not limited to, chewing gum (which includes sugarized gum, sugar-free gum, functional gum and bubble gum), centerfill confections, chocolate and other chocolate confectionery, medicated confectionery, lozenges, tablets, pastilles, mints, standard mints, power mints, chewy candies, hard candies, boiled candies, breath and other oral care films or strips, candy canes, lollipops, gummies, jellies, fudge, caramel, hard and soft panned goods, toffee, taffy, liquorice, gelatin candies, gum drops, jelly beans, nougats, fondants, combinations of one or more of the above, and edible flavour compositions incorporating one or more of the above.

Exemplary baked products include, but are not limited to, alfajores, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savoury biscuits and crackers, bread substitutes.

Exemplary sweet products include, but are not limited to, breakfast cereals, ready-to-eat (“rte”) cereals, family breakfast cereals, flakes, muesli, other ready to eat cereals, children's breakfast cereals, hot cereals.

Exemplary dairy products include, but are not limited to, cheese, cheese sauces, cheese-based products, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured, functional and other condensed milk, flavoured milk drinks, dairy only flavoured milk drinks, flavoured milk drinks with fruit juice, soy milk, sour milk drinks, fermented dairy drinks, coffee whiteners, powder milk, flavoured powder milk drinks, cream, yoghurt, plain/natural yoghurt, flavoured yoghurt, fruited yoghurt, probiotic yoghurt, drinking yoghurt, regular drinking yoghurt, probiotic drinking yoghurt, chilled and shelf-stable desserts, dairy-based desserts, soy-based desserts.

The flavor compositions may also be admixed with other bases, components, compounds, compositions, elements, ingredients, and/or materials to prepare flavored chewing gums and oral care products. Oral care products include any composition applied to the oral cavity for the purposes of cleaning, freshening, healing, deodorising the cavity or any part thereof, may include, but are not limited to, toothpastes, tooth gels, tooth powders, tooth whitening products, mouthwashes, lozenges, dental floss, toothpicks, anti-plaque compositions, anti-gingivitis compositions, throat lozenges, throat drops, mouthwash compositions, and other gargle compositions.

The flavor compositions may also be admixed with other bases, components, compounds, compositions, elements, ingredients, and/or materials to prepare flavored tobacco products. For example, and without limitation, tobacco products include cigars, cigarettes, smokeless chewing tobacco, and smokeless dipping tobacco (also known as moist snuff).

According to certain illustrative embodiments, the insect-derived flavor compositions can be used to prepare an edible or consumable food product. According to certain illustrative embodiments, the insect-derived flavor composition may be added to a food base to prepare an edible or consumable food product. The insect-derived flavor compositions may be added to an uncooked food base before and/or during the cooking process. According to certain illustrative embodiments, the insect-derived flavor composition is added to an uncooked food base prior to the cooking process. According to other illustrative embodiments, the insect-derived flavor composition is added to an uncooked food base during the cooking process. According to further illustrative embodiments, the insect-derived flavor composition is added to an uncooked food base both before and during the cooking process. The addition of the insect-derived flavor composition to the uncooked food base imparts a desired meaty or meat-like taste and aroma to the resulting cooked food product.

The insect-derived flavor composition may be added to a food base to prepare a cooked food product having meat-like flavor and/or aroma profile. For example, and without limitation, the insect-derived flavor composition may be added to a food base to prepare a cooked food product having a meat-like flavor and/or aroma profile that approximate the flavor and/or aroma profiles of beef, chicken, duck, turkey, deer, pork, or other edible meat flavor.

For preparation of the food product using the flavor composition comprising the insect-derived material, it is possible to add a flavor composition comprising an insect-derived fat to a food product base, or to add a flavor composition comprising an insect-derived protein to a food product base, or to add a flavor composition comprising an admixed combination of an insect-derived fat and an insect-derived protein to a food product base, or to separately add an individual flavor composition comprising an insect-derived fat and an individual flavor composition comprising an insect-derived protein.

For preparation of the food product using the flavor composition developed with the insect-derived material, it is possible to add a flavor composition developed with an insect-derived fat to a food product base, or to add a flavor composition developed with an insect-derived protein to a food product base, or to add a flavor composition developed with an admixed combination of an insect-derived fat and an insect-derived protein to a food product base, or to separately add an individual flavor composition developed with an insect-derived fat and an individual flavor composition developed with an insect-derived protein.

According to certain illustrative embodiments, the insect-derived flavor composition is admixed with a food base in amount from about 0.001 to about 10% and any and all values in between. According to other illustrative embodiments, the insect-derived flavor composition is admixed with a food base in amount from about 0.01 to about 5% and any and all values in between. According to other illustrative embodiments, the insect-derived flavor composition is admixed with a food base.

According to certain illustrative embodiments, a flavor composition developed with an insect-derived protein is admixed with a food base in amount from about 0.001 to about 10% and any and all values in between. According to other illustrative embodiments, a flavor composition developed with an insect-derived protein is admixed with a food base in amount from about 0.01 to about 5% and any and all values in between. According to other illustrative embodiments, a flavor composition developed with an insect-derived protein is admixed with a food base.

According to certain illustrative embodiments, a flavor composition developed with an insect-derived fat is admixed with a food base in amount from about 0.001 to about 10% and any and all values in between. According to other illustrative embodiments, a flavor composition developed with an insect-derived fat is admixed with a food base in amount from about 0.01 to about 5% and any and all values in between. According to other illustrative embodiments, a flavor composition developed with an insect-derived fat is admixed with a food base.

According to certain illustrative embodiments, a flavor composition developed with insect-derived fat and insect-derived protein is admixed with a food base in amount from about 0.001 to about 10% and any and all values in between. According to other illustrative embodiments, a flavor composition developed with insect-derived fat and insect-derived protein admixed with a food base.

The present disclosure also includes a method of imparting a flavor to a consumable composition. The method comprises admixing, blending, combining, contacting or mixing a consumable food base with a flavor composition comprising an insect-derived material selected from insect-derived protein and insect-derived fat.

The present disclosure also includes a method of affecting a flavor profile of a consumable composition. The method comprises admixing, blending, combining, contacting or mixing a consumable food base with a flavor composition comprising an insect-derived material selected from insect-derived protein and insect-derived fat. The term “affecting” means enhancing, decreasing or modulating the flavor profile of a consumable composition.

The present disclosure also includes a method of affecting an aroma profile of a consumable composition. The method comprises admixing, blending, combining, contacting or mixing a consumable food base with a flavor composition comprising an insect-derived material selected from insect-derived protein and insect-derived fat. The term “affecting” means enhancing, decreasing or modulating the aroma profile of a consumable composition.

### EXAMPLES

The following examples are provided solely for the purpose of illustrative and are not to be construed as limiting the presently claimed subject matter in any manner. Many variations of the claimed subject matter are possible without departing from the spirit and scope of the disclosure and claims. The flavor compositions, consumable compositions, and related methods or preparing the flavor and consumable compositions are not limited to the specific embodiments described above, but includes variations, modifications and equivalent embodiments defined by the appended claims. The illustrative embodiments described above are not necessarily in the alternative, as various embodiments may be combined to provide the desired advantages, benefits and characteristics.

Process flavors were selected to evaluate the performance of insect-derived protein or fat as compared to conventional animal-based protein and fat flavors, and plant-derived material. Process flavors are also referred to as reaction flavors. See for example Weerasinghe and Sucan in ACS Symposium Series, American Chemical Society, Chapter 1 “Process and Reaction Flavors: An Overview” at pages 1-23 (2005). Process flavors can be created separate from a consumable or they can be created during the preparation/production of a consumable.

### Preparation of Sample Process Flavors

The insect-derived protein and insect-derived fat were evaluated in the different process flavor formulations as forth below:

Protein origin was replaced by either insect protein G or insect protein M. Other ingredients are named I 1-x. For the different Process flavours, I1-Ix are not the same.

| Protein 1 | 1000 |
|---|---|
| WATER DRINKABLE GRADE | 485.7 |
| Protein origin1 | 211.0 |
| I1 | 23.0 |
| I2 | 2.5 |
| I3 | 2.0 |
| I4 | 1.1 |
| I5 | 29.7 |
| I6 | 31.6 |
| I7 | 7.4 |
| I8 | 29.5 |
| I9 | 3.6 |
| I10 | 3.8 |
| I11 | 4.7 |
| I12 | 38.2 |
| I13 | 6.2 |
| I14 | 80.0 |
| I15 | 40.0 |

| Fat 1 | 1000 |
|---|---|
| WATER DRINKABLE GRADE | 361.2 |
| I1 | 224.2 |
| I2 | 42 |
| I3 | 21 |
| I4 | 37.1 |
| Fat Origin1 | 314.3 |
| I5 | 0.2 |

| Protein or protein/fat | 1000 |
|---|---|
| WATER hot | 504.4 |
| I1 | 148.3 |
| Protein or protein/fat origin1 | 123.9 |
| I2 | 59.3 |
| I3 | 164.0 |

### Sensory Evaluation Protocol

A tasting session was organized and conducted with expert process flavorists to evaluate the flavor profile of the process flavor compositions. The results of the tasting session are set forth in the following Table 1:

TABLE 1

| Sample | Type Insect | | Dosage | Comments | |
|---|---|---|---|---|---|
| Ref A. | | | 0.20% | Color: | light yellowish, homogenous, grease drops |
| | | | | Smell: | |
| | | Egg Yolk | | Taste: | eggy, sulfury, chicken, fatty, rounded |
| A.1 | Hermetia | | 0.20% | Color: | brownish, sediments, no grease drops |
| | illucens | | | Smell: | |
| | Larvae | Protein | | Taste: | Slightly meaty, powdery, dry, chicken |
| | | | | | meat, no eggy/sulfury, cardboard, cereal, |
| | | | | | sweetish, slightly roasted, wet paper |
| A.2 | Hermetia | | 0.20% | Color: | brownish, sediments, grease drops |
| | illucens | | | Smell: | |
| | Larvae | Protein | | Taste: | neurtral, bouillon, “scratchy”, slightly eggy, |
| | | | | | close to ref., slightly metallic, slightly |
| | | | | | Blody, piperine effect, boiled meat, |
| | | | | | pleasant |
| A.3 | Tenebrio | | 0.20% | Color: | little grease drops |
| | molitor | | | Smell: | |
| | Larvae | Protein | | Taste: | neutral, bouillon, roasty chicken skin, |
| | | | | | fruity/terpene like |
| A.4 | locusta | | 0.20% | Color: | grease drops |
| | migratoria | | | Smell: | |
| | Adult | Protein | | Taste: | Slightly fishy, mushroom, livery, |
| | | | | | green/spinach, baked note, no sulfur, |
| | | | | | slightly sweet |
| Ref. B | | | 0.20% | Color: | clear, slightly yellowish, grease drops |
| | | | | Smell: | |
| | | Lamb Fat | | Taste: | fatty, slightly dirty, animalic, marrow, |
| | | | | | slightly caramel |
| B.5 | Hermetia | | 0.20% | Color: | clear, slightly yellowish, grease drops |
| | illucens | | | Smell: | |
| | Larvae | Insect Fat | | Taste: | caramel, burnt sugar, oily, no |
| | | | | | animalic/marrow, grean wheat, sweeetish, |
| | | | | | round |
| Ref. C | | | 0.05% | Color: | |
| | | | | Smell: | |
| | | Egg Yolk | | Taste: | white meat, slightly chicken, sulfury, |
| | | | | | eggy/fatty |
| C.6 | Hermetia | | 0.05% | Color: | |
| | illucens | | | Smell: | |
| | Larvae | Protein | | Taste: | scratchy, dry, powdery, cardboard, slightly |
| | | | | | eggy, slightly green, sweetish, papery, lack |
| | | | | | in sulfur |
| C.7 | Hermetia | | 0.05% | Color: | |
| | illucens | | | Smell: | |
| | Larvae | Protein | | Taste: | intense, slightly fatty, close to ref, bouillon, |
| | | | | | mild, neutral, savoury, meaty, lack in sulfur |

The taste profiles of the insect-derived process flavor compositions are different from the animal-material based flavor compositions. The insect-derived samples did not exhibit the sulfury notes that are traditionally experienced with egg yolk. The insect-derived process flavors containing insect-derived protein instead of egg yolk exhibited a rather neutral, boullion or white meat type of taste profile. These insect protein process flavors displayed good mouthfeel and no moldy character as that of yeast extract, nor did it display a yeast-type off note flavor. The insect-derived process flavors containing insect-derived oil instead of lamb fat exhibited a sweetish, oily, sometimes cereal taste profile. The insect-derived samples also did not exhibit the animalic notes that are traditionally associated with lamb fat based flavors.

These results indicate that insect-derived materials, such as insect-derived proteins and insect-derived fats can be incorporated into process or reaction flavors to prepare process or reaction flavors that are free or substantially free of traditional meat or fish proteins. These insect-based process and reaction flavors can be used for the preparation of a wide variety of consumable, edible, ingestible compositions, such as foodstuffs and feeds, for humans and non-human animals.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

1. A flavor composition comprising an insect-derived material selected from insect-derived protein, insect-derived fat, and combinations thereof.

2. The flavor composition of claim 1 is a process flavor.

3. The flavor composition of claim 2 comprising an insect-derived protein.

4. The flavor composition of claim 2 comprising an insect-derived fat.

5. The flavor composition of claim 2 wherein said insect-derived protein is obtained from a species of insect classified in the Family Stratiomyidae.

6. The flavor composition of claim 5 wherein said species of insect is Hermetia illucens.

7. The flavor composition of claim 2 wherein said insect-derived protein is obtained from a species of insect classified in the Family Tenebrionidae.

8. The flavor composition of claim 7 wherein said species of insect is Tenebrio molitor.

9. The flavor composition of claim 2 wherein said insect-derived protein is obtained from a species of insect classified in the Family Arcididae.

10. The flavor composition of claim 9 wherein said species of insect is Locusta migratoria.

11. A consumable composition comprising a consumable base and a flavor composition comprising an insect-derived material selected from insect-derived protein, insect-derived fat, and combinations thereof.

12. The consumable composition of claim 11, wherein the flavor composition is a process flavor.

13. The consumable composition of claim 12 wherein said flavor composition comprises an insect-derived protein.

14. The consumable composition of claim 12 wherein said flavor composition comprises an insect-derived fat.

15. The consumable composition of claim 12 wherein said insect-derived protein is obtained from a species of insect classified in the Family Stratiomyidae.

16. The consumable composition of claim 15 wherein said species of insect is Hermetia illucens.

17. The consumable composition of claim 12 wherein said insect-derived protein is obtained from a species of insect classified in the Family Tenebrionidae.

18. The consumable composition of claim 17 wherein said species of insect is Tenebrio molitor.

19. The consumable composition of claim 12 wherein said insect-derived protein is obtained from a species of insect classified in the Family Arcididae.

20. A method of imparting a flavor to a consumable, the method comprising combining a consumable base with a flavor composition comprising an insect-derived material selected from insect-derived protein, insect-derived fat, and combinations thereof.
